(19) United States
(12) Patent Application Publication
(10) Pub. No.: US 2017/0029621 A1
(43) Pub. Date: Feb. 2, 2017

(54) Polyamide Resin Composition and Article Produced Therefrom

(71) Applicant: Samsung SDI Co., Ltd., Yongin-si (KR)

(72) Inventors: Nam Hyun KIM, Uiwang-si (KR); Chan Gyun SHIN, Uiwang-si (KR); Sang Hyun HONG, Uiwang-si (KR); Jee Kwon PARK, Uiwang-si (KR)

(21) Appl. No.: 15/222,254

(22) Filed: Jul. 28, 2016

(30) Foreign Application Priority Data
Jul. 31, 2015 (KR) 10-2015-0109221

(51) Int. Cl. C08L 77/06

(52) U.S. Cl. CPC C08L 77/06

(57) ABSTRACT

A polyamide resin composition and a molded article manufactured using the same. The polyamide resin composition includes: a base resin comprising an aliphatic polyamide resin having a terminal amine group concentration of about 0.1 μeq/g to about 45 μeq/g and including a repeat unit represented by the following Formula 1 wherein a is an integer from 4 to 10, and b is an integer from 6 to 12 and an aromatic polyamide resin including a repeat unit represented by the following Formula 2 wherein c is an integer from 6 to 12; and inorganic fillers. The polyamide resin composition can exhibit excellent properties in terms of impact resistance, stiffness, processability, appearance, and balance therebetween.

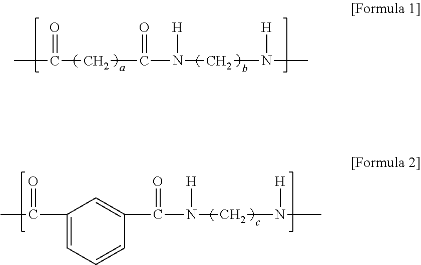

### CROSS-REFERENCE TO RELATED APPLICATION

This application claims priority under 35 USC Section 119 to and the benefit of

Korean Patent Application 10-2015-0109221, filed on Jul. 31, 2015, the entire disclosure of which is incorporated herein by reference.

### FIELD OF THE INVENTION

The present invention relates to a polyamide resin composition and a molded article formed of the same.

### BACKGROUND

A thermoplastic resin composition has a lower specific gravity than glass or metal and has excellent properties in terms of processability and impact resistance and is thus useful as materials for a housing of electric/electronic products, automotive interior/exterior materials, and exterior materials for construction. Particularly, with the trend of reducing weight and thickness of electric/electronic products, plastic products using such a thermoplastic resin are rapidly replacing glass or metal products.

When inorganic fillers such as glass fibers are mixed with a thermoplastic resin such as a polyamide resin, it is possible to improve flexural properties such as flexural modulus (stiffness) and flexural strength of the resin due to intrinsic characteristics of the inorganic fillers. Generally, a blend of a polyamide resin and inorganic fillers is used in fabricating a molded article requiring high stiffness. Particularly, such a blend is widely used as interior/exterior materials for electric/electronic products and automotive parts.

Conventionally, as a polyamide resin, a (semi-) aromatic polyamide resin such as polyamide 6T and polyamide MXD6, which are polymers of an aromatic dicarboxylic acid and an aliphatic diol; an aliphatic polyamide resin such as polyamide 66, which is a polymer of an aliphatic dicarboxylic acid and an aliphatic diol; and combinations thereof have been used.

However, when such polyamide resins are mixed with inorganic fillers, melting of the resin can increase and the resin can suffer from deterioration in processability (flowability) and appearance due to increase in molecular weight (viscosity) caused by chain extension during high-temperature molding. In addition, when the amount of inorganic fillers is increased to secure a certain level of stiffness, there is a concern of deterioration in impact resistance and flowability due to reduction in ductility of the resin.

Further, there has been proposed use of a rubbery impact modifier for improvement in impact resistance. Such an impact modifier, however, can have poor heat-stability and thus can cause bad appearance of a product due to generation of a gas during processing or residence at high temperature.

Therefore, there is a need for a polyamide resin composition which can exhibit excellent properties in terms of impact resistance, stiffness, processability, appearance, and balance therebetween upon introduction of a high content of inorganic fillers without using a separate impact modifier.

### SUMMARY OF THE INVENTION

Embodiments of the present invention provide a polyamide resin composition which can exhibit excellent properties in terms of impact resistance, stiffness, processability, appearance, and a balance therebetween, and a molded article formed of the same.

The polyamide resin composition includes: a base resin comprising an aliphatic polyamide resin having a concentration of a terminal amine group of about 0.1 μeq/g to about 45 μeq/g and including a repeat unit represented by the following Formula 1 and an aromatic polyamide resin including a repeat unit represented by the following Formula 2; and inorganic fillers:

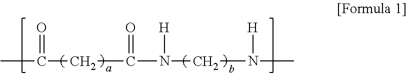

wherein a is an integer from 4 to 10, and b is an integer from 6 to 12;

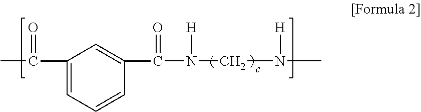

wherein c is an integer from 6 to 12.

In exemplary embodiments, the aliphatic polyamide resin may be present in an amount of about 50 wt % to about 90 wt % based on the total weight of the base resin; the aromatic polyamide resin may be present in an amount of about 10 wt % to about 50 wt % based on the total weight of the base resin; and the inorganic fillers may be present in an amount of about 50 parts by weight to about 500 parts by weight based on about 100 parts by weight of the base resin.

In exemplary embodiments, the aliphatic polyamide resin may have the terminal amine group and a terminal carboxyl group, and a concentration of the terminal amine group may range from about 10 μeq/g to about 40 μeq/g and the concentration of the terminal amine group can be about 0.1 times to about 0.3 times the concentration of the terminal carboxyl group.

In exemplary embodiments, the aliphatic polyamide resin may have an intrinsic viscosity of about 0.9 dL/g to about 1.2 dL/g; the aromatic polyamide resin may have an intrinsic viscosity of about 0.6 dL/g to about 1.0 dL/g; and the base resin may have an intrinsic viscosity of about 1.0 dL/g to about 1.1 dL/g.

In exemplary embodiments, the aliphatic polyamide resin may be polyamide 66, and the aromatic polyamide resin may be polyamide 61.

In exemplary embodiments, the inorganic fillers may be glass fibers, and the glass fibers may take a fibrous form and have a sectional diameter of about 5 μm to about 20 μm and a ratio of minor axis to major axis of about 1:about 1 to about 1: about 6 in a cross-sectional view thereof.

In exemplary embodiments, the glass fibers may be surface-treated with a coupling agent including at least one of a urethane coupling agent, a silane coupling agent, and an epoxy coupling agent.

In exemplary embodiments, the polyamide resin composition may have an intrinsic viscosity of about 1.0 dL/g to about 1.1 dL/g, and a difference in intrinsic viscosity between the base resin and the polyamide resin composition may be about 0.05 dL/g or less.

In exemplary embodiments, the polyamide resin composition may have a notched Izod impact strength of about 10 kgf·cm/cm to about 30 kgf·cm/cm, as measured on an about ⅛″ thick specimen in accordance with ASTM D256.

In exemplary embodiments, the polyamide resin composition may have a spiral flow length of about 95 mm to about 160 mm, as measured on a specimen prepared by injection molding under conditions of a molding temperature of about 300° C., a mold temperature of about 80° C., an injection pressure of about 1,500 kgf/cm², and an injection rate of about 120 mm/s in a spiral mold having a thickness of about 0.5 mm.

In exemplary embodiments, the polyamide resin composition may have a falling dart impact strength of about 40 cm to about 80 cm, as measured on an about 0.8 mm thick specimen (about 10 cm×about 10 cm×about 0.8 mm) using an about 500 g dart in accordance with the DuPont drop test method by measuring a height of the dart at which the specimen is cracked.

Other embodiments of the present invention relate a molded article formed of the polyamide resin composition as set forth above.

### BRIEF DESCRIPTION OF THE DRAWINGS

FIG. 1 is a surface image of a specimen prepared according to Example 2.

FIG. 2 is a surface image of a specimen prepared according to Comparative Example 3.

FIG. 3 is a surface image of a specimen prepared according to Comparative Example 4.

### DETAILED DESCRIPTION

The above and other aspects, features, and advantages of the present invention will become apparent from the detailed description of the following embodiments. It should be understood that the present invention is not limited to the following embodiments and may be embodied in different ways, and that the embodiments are provided for complete disclosure and thorough understanding of the present invention by those skilled in the art. The scope of the present invention should be defined only by the appended claims.

A polyamide resin composition according to the present invention includes: (A) a base resin including (a1) an aliphatic polyamide resin having a concentration of a terminal amine group of about 0.1 μeq/g to about 45 μeq/g and (a2) an aromatic polyamide resin; and (B) inorganic fillers.

(A) Base Resin

The base resin (polyamide resin) includes the (a1) aliphatic polyamide resin and the (a2) aromatic polyamide resin.

(a1) Aliphatic Polyamide Resin

The aliphatic polyamide resin serves to suppress chain extension due to additional polymerization in processing of the polyamide resin composition and may be an aliphatic polyamide resin having a concentration of a terminal amine group of about 0.1 μeq/g to about 45 μeq/g and including a repeat unit represented by the following Formula 1:

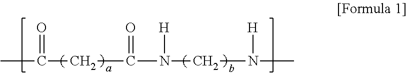

wherein a is an integer from 4 to 10, and b is an integer from 6 to 12.

In exemplary embodiments, the aliphatic polyamide resin includes the terminal amine group and a terminal carboxyl group, and the concentration of the terminal amine group may range from about 0.1 μeq/g to about 45 μeq/g, for example, about 10 μeq/g to about 40 μeq/g. If the concentration of the terminal amine group exceeds about 45 μeq/g, there is a concern of deterioration in processability and appearance due to increase in molecular weight and viscosity of the polyamide resin during molding of the polyamide resin composition, whereas if the concentration of the terminal amine group is less than about 0.1 μeq/g, it is difficult to prepare the polyamide resin.

In addition, in the aliphatic polyamide resin, the concentration of the terminal amine group may be about 0.1 to about 0.3 times, for example, about 0.15 to about 0.25 times the concentration of the terminal carboxyl group. Within this range, the polyamide resin composition can exhibit excellent properties in terms of processability and appearance.

Examples of the aliphatic polyamide resin may include without limitation polyamide (PA) 6, polyamide 66, polyamide 46, polyamide 610, polyamide 611, polyamide 612, polyamide 1010, polyamide 1011, polyamide 1111, polyamide 1212, and the like, and combinations thereof. For example, the aliphatic polyamide resin may be polyamide 66.

In exemplary embodiments, the aliphatic polyamide resin may have an intrinsic viscosity (IV) of about 0.9 dL/g to about 1.2 dL/g, for example, about 1.0 dL/g to about 1.1 dL/g, as measured at 25° C. after the resin is dissolved in concentrated sulfuric acid (96%) at a concentration of about 0.5 g/dL. Within this range, the polyamide resin composition can exhibit excellent properties in terms of flowability and balance between flowability and other physical properties.

In exemplary embodiments, the base resin can include the aliphatic polyamide resin in an amount of about 50 wt % to about 90 wt %, for example, about 60 to about 85 wt %, based on the total weight (100 wt %) of the base resin. In some embodiments, the base resin can include the aliphatic polyamide resin in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 wt %. Further, according to some embodiments, the amount of the aliphatic polyamide resin can be in a range from about any of the foregoing amounts to about any other of the foregoing amounts.

Within this range, the polyamide resin composition can exhibit excellent properties in terms of impact resistance, stiffness, processability, appearance, and balance therebetween.

(a2) Aromatic Polyamide Resin

The aromatic polyamide resin can provide improved ductility to the polyamide resin composition, as compared with typical crystalline (semi-) aromatic polyamide resins such as polyamide 6T, and can reduce a crystallization rate of the aliphatic polyamide resin, such that the polyamide resin composition can exhibit improved properties in terms of impact resistance, stiffness, processability, and appearance upon introduction of a high content of glass fibers. The aromatic polyamide resin may be a (semi-) aromatic polyamide resin including a repeat unit represented by Formula 2.

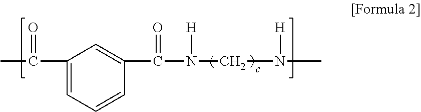

wherein c is an integer from 6 to 12.

Examples of the aromatic polyamide resin may include without limitation polyamide (PA) 6I, polyamide 7I, polyamide 8I, polyamide 9I, polyamide 10I, polyamide 11I, polyamide 12I, and the like, and combinations thereof. For example, the aromatic polyamide resin may be polyamide 61.

In exemplary embodiments, the aromatic polyamide resin may have an intrinsic viscosity (IV) of about 0.6 dL/g to about 1.0 dL/g, for example, about 0.7 dL/g to about 0.9 dL/g, as measured at 25° C. after the resin is dissolved in concentrated sulfuric acid (96%) at a concentration of about 0.5 g/dL. Within this range, the polyamide resin composition can exhibit excellent properties in terms of flowability and balance between flowability and other physical properties.

In exemplary embodiments, the base resin can include the aromatic polyamide resin in an amount of about 10 wt % to about 50 wt %, for example, about 15 wt % to about 40 wt %, based on the total weight (100 wt %) of the base resin. In some embodiments, the base resin can include the aromatic polyamide resin in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt %. Further, according to some embodiments, the amount of the aromatic polyamide resin can be in a range from about any of the foregoing amounts to about any other of the foregoing amounts.

Within this range, the polyamide resin composition can exhibit excellent properties in terms of impact resistance, stiffness, processability, appearance, and balance therebetween.

In exemplary embodiments, the base resin (aliphatic and aromatic polyamide resins) may have an intrinsic viscosity (IV) of about 1.0 dL/g to about 1.1 dL/g, for example, about 1.01 dL/g to about 1.05 dL/g, as measured at 25° C. after the resin is dissolved in concentrated sulfuric acid (96%) at a concentration of about 0.5 g/dL. Within this range, the polyamide resin composition can exhibit excellent properties in terms of flowability and the like.

(B) Inorganic Fillers

The inorganic fillers serve to improve flexural modulus (stiffness) of the polyamide resin composition and may include any inorganic fillers used in a typical thermoplastic resin composition without limitation. For example, the inorganic fillers may be glass fibers, for example glass fibers prepared by any suitable method known in the art or any commercially available glass fibers.

In exemplary embodiments, the glass fibers may take a fibrous and/or granular form and may have various shapes such as circular, elliptical, and/or rectangular shapes in section. For example, when the glass fibers have a circular (elliptical) shape in section, the glass fibers may have a sectional diameter of about 5 μm to about 20 μm, for example, about 6 μm to about 18 μm and a ratio of minor axis (diameter) to major axis (diameter) of about 1: about 1 to about 1: about 6, for example, about 1: about 1 to about 1: about 4 in a cross-sectional view. Within this range, the polyamide resin composition can exhibit better stiffness, impact resistance, flowability, and flexural characteristics.

In exemplary embodiments, the glass fibers may have an average length (before processing) of about 2 mm to about 6 mm, for example, about 2 mm to about 4 mm. Within this range, the polyamide resin composition can exhibit excellent properties in terms of impact resistance, stiffness, appearance, and balance therebetween.

In exemplary embodiments, the glass fibers may be surface-treated with a coupling agent to prevent reaction with the polyamide resin (base resin) and to improve cohesion. Examples of the coupling agent include without limitation urethane coupling agents, silane coupling agents, epoxy coupling agents, and the like, and combinations thereof. Here, surface treatment may be performed by any suitable coating process known in the art, such as dip coating and spray coating.

In exemplary embodiments, the polyamide resin composition can include the inorganic fillers in an amount of about 50 parts by weight to about 500 parts by weight, for example, about 80 parts by weight to about 300 parts by weight, based on about 100 parts by weight of the base resin. Within this range, the polyamide resin composition can exhibit excellent properties in terms of impact resistance, stiffness, processability, appearance, and balance therebetween.

The polyamide resin composition may optionally include a thermoplastic resin composition other than (in addition to) the polyamide resin, for example, a thermoplastic resin composition including a polycarbonate resin, a polyester resin, an aromatic vinyl resin, or a combination (or blend) thereof, and optionally one or more additives without altering advantageous effects of the invention. Examples of the additives may include without limitation flame retardants, antioxidants, lubricants, release agents, nucleating agents, antistatic agents, stabilizers, colorants, and the like, and mixtures thereof. When the additives are used, the additives may be present in an amount of about 10 parts by weight or less based on about 100 parts by weight of the polyamide resin.

The polyamide resin composition may have an intrinsic viscosity (IV) of about 1.0 dL/g to about 1.1 dL/g, for example, about 1.02 dL/g to about 1.06 dL/g, as measured at about 25° C. after the resin composition is dissolved in concentrated sulfuric acid (about 96%) at a concentration of about 0.5 g/dL. A difference in intrinsic viscosity between the polyamide resin (base resin) and the polyamide resin composition may be about 0.05 dL/g or less, for example, about 0.02 dL/g or less. Within this range, the polyamide resin composition can exhibit excellent properties in terms of flowability (processability), appearance, and the like.

In exemplary embodiments, the polyamide resin composition may have a notched Izod impact strength of about 10 kgf·cm/cm to about 30 kgf·cm/cm, for example, about 10 to about 25 kgf·cm/cm, for example about 12 kgf·cm/cm to about 20 kgf·cm/cm, as measured on an about ⅛″ thick specimen in accordance with ASTM D256. Within this range, the polyamide resin composition can exhibit excellent impact resistance.

In exemplary embodiments, the polyamide resin composition may have a flexural modulus (FM) of about 10 GPa to about 35 GPa, for example, about 10 GPa to about 30 GPa, as measured on an about 6.4 mm thick specimen at a rate of about 2.8 mm/min in accordance with ASTM D790. Within this range, the polyamide resin composition can exhibit excellent stiffness.

In exemplary embodiments, the polyamide resin composition may have a spiral flow length of about 95 mm to about 160 mm, for example, about 98 mm to about 120 mm, as measured on a specimen prepared by injection molding under conditions of a molding temperature of about 300° C., a mold temperature of about 80° C., an injection pressure of about 1,500 kgf/cm², and an injection rate of about 120 mm/s in a spiral mold having a thickness of about 0.5 mm. Within this range, the polyamide resin composition can exhibit excellent processability (injection moldability).

In exemplary embodiments, the polyamide resin composition may have a falling dart impact strength of about 40 cm to about 80 cm, for example, about 42 cm to about 55 cm, as measured on an about 0.8 mm thick specimen (about 10 cm×about 10 cm×about 0.8 mm) using an about 500 g dart in accordance with the DuPont drop test method by measuring a height of the dart at which the specimen is cracked. Within this range, the polyamide resin composition can exhibit excellent impact resistance.

A molded article according to the present invention is formed of the polyamide resin composition as set forth above. The polyamide resin composition may be prepared by any suitable thermoplastic resin composition preparation method known in the art. For example, the aforementioned components and, optionally, the additives are mixed, followed by melt extrusion in an extruder, thereby preparing a polyamide resin composition in pellet form. The prepared pellets may be produced into various molded articles (products) by various molding methods such as injection molding, extrusion, vacuum molding, and casting. Such molding methods are well known to those skilled in the art to which the present invention pertains. The molded article may be applied to various fields such as interior/exterior materials for electric/electronic products. For example, the molded article can be useful as interior/exterior materials for mobile phones, which require high stiffness and high-quality appearance.

Hereinafter, the present invention will be described in more detail with reference to the following examples. It should be understood that these examples are provided for illustration only and are not to be construed in any way as limiting the present invention.

### EXAMPLE

Details of components used in the following Examples and Comparative Examples are as follows:

(A) Polyamide resin

(a1) Aliphatic Polyamide Resin

Polyamide 66 ((a1-1), (a1-2), (a1-3)) as listed in Table 1 is used.

TABLE 1

| | Intrinsic | | Terminal carboxyl |
|---|---|---|---|
| | viscosity | Terminal amine group | group concentration |
| | (dL/g) | concentration (μeq/g) | (μeq/g) |
| (a1-1) PA66 | 1.07 | 37 | 155 |
| (a1-2) PA66 | 1.03 | 50 | 121 |
| (a1-3) PA66 | 1.08 | 54 | 152 |

(a2) Aromatic Polyamide Resin

(a2-1) Polyamide 61 having an intrinsic viscosity of 0.7 dL/g is used.

(a2-2) Polyamide MXD6 having an intrinsic viscosity of 0.8 dL/g is used.

(B) Inorganic Fillers

Glass fibers (CSF 3PE-455, NITTOBO ASIA Glass Fiber Co. Ltd., diameter: 13 μm, length: 3 mm) are used.

### Examples 1 to 3 and Comparative Examples 1 to 4

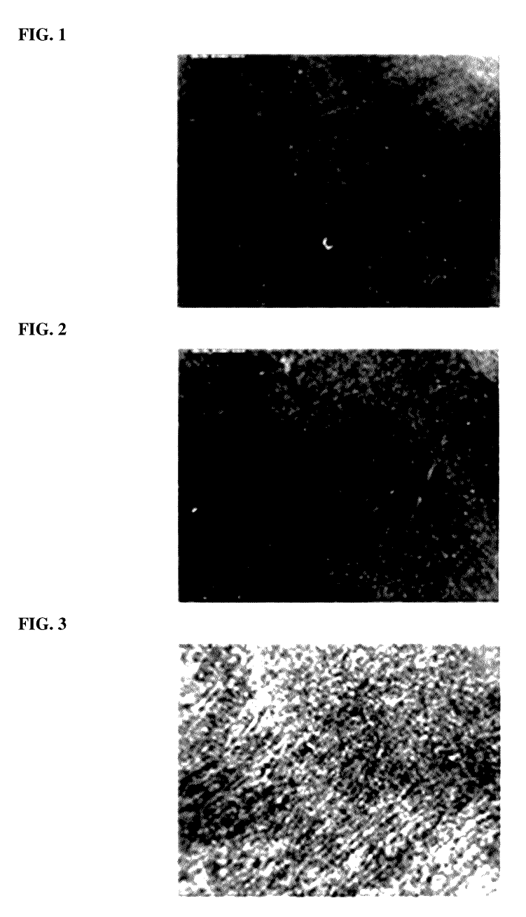

The above components are mixed in amounts as listed in Table 1 and placed into a twin-screw extruder having L/D of 36 and a diameter of 45 mm, followed by melt extrusion at a temperature of 250° C., a screw speed of 200 rpm, and a discharge rate of 80 kg/hr, thereby preparing a polyamide resin composition in pellet form. The prepared pellets are dried at 100° C. for 4 hours or more, followed by injection molding using an injection molding machine at an injection temperature of 350° C. and a mold temperature of 80° C., thereby preparing a specimen for property evaluation. The prepared specimen is evaluated as the following properties, and results are shown in Table 2. In addition, surface images of specimens prepared according to Example 2 and Comparative Examples 3 and 4 are shown in FIGS. 1, 2 and 3, respectively.

Property Evaluation

(1) Intrinsic viscosity (IV) of base resin (unit: dL/g): A base resin ((a1)+(a2)) as listed in Table 2 is dissolved in concentrated sulfuric acid (96%) at a concentration of 0.5 g/dL, followed by measuring intrinsic viscosity of the base resin at 25° C. using an Ubbelohde viscometer.

(2) Intrinsic viscosity (IV) of polyamide resin composition (unit: dL/g): A polyamide resin composition ((a1)+(a2)+(B)) as listed in Table 2 is dissolved in concentrated sulfuric acid (96%) at a concentration of 0.5 g/dL, followed by measuring intrinsic viscosity of the resin composition at 25° C. using an Ubbelohde viscometer.

(3) Spiral flow length (unit: mm): A specimen is prepared by injection molding under conditions of a molding temperature of 300° C., a mold temperature of 80° C., an injection pressure of 1,500 kgf/cm², and an injection rate of 120 mm/s in a spiral mold having a thickness of 0.5 mm using an injection molding machine (LGE 110 II , LS MTRON LTD.), followed by measuring length of the specimen. A greater length value indicates better moldability.

(4) Notched Izod impact strength (unit: kgf·cm/cm): Izod impact strength is measured on a ⅛″ thick notched specimen in accordance with ASTM D256.

(5) Falling dart impact strength (unit: cm): A 500 g dart is dropped on a 0.8 mm thick specimen (10 cm×10 cm×0.8 mm) in accordance with the DuPont drop test method to measure a height of the dart at which the specimen is cracked. A greater height value indicates better impact resistance.

(6) Flexural modulus (FM) (unit: GPa): Flexural modulus is measured on a 6.4 mm thick specimen at a rate of 2.8 mm/min in accordance with ASTM D790.

(7) Appearance: Whether glass fibers protrude from a surface of a specimen is observed using an optical microscope, followed by sensory evaluation. Evaluation criteria are as follows:

Comparative Example 2 using polyamide MXD6 is used as a reference specimen. A specimen for evaluation is rated as ⊚ (good) when the specimen has better appearance than the reference specimen (when protruding glass fibers are not observed), rated as rated as ◯ (fair) when the specimen has an appearance equivalent to that of the reference specimen (when protruding glass fibers are partially observed), and rated as Δ (poor) when the specimen has worse appearance than the reference specimen (when protruding glass fibers are observed all over the surface)

TABLE 2

| | | Example | | | Comparative Example | | | |
|---|---|---|---|---|---|---|---|---|
| | | 1 | 2 | 3 | 1 | 2 | 3 | 4 |
| (a1) | (a1-1) | 80 | 70 | 60 | — | — | 70 | 100 |
| (wt %) | (a1-2) | — | — | | 70 | — | — | — |
| | (a1-3) | — | — | — | — | 70 | — | — |
| (a2) | (a2-1) | 20 | 30 | 40 | 30 | 30 | — | — |
| (wt %) | (a2-2) | — | — | — | — | — | 30 | — |

| | | | | | | | |
|---|---|---|---|---|---|---|---|
| (B) (parts by weight) | 100 | 100 | 100 | 100 | 100 | 100 | 100 |
| IV of polyamide resin | 1.05 | 1.04 | 1.01 | 1.08 | 1.11 | 1.05 | 1.14 |
| IV of polyamide resin | 1.06 | 1.04 | 1.02 | 1.16 | 1.17 | 1.08 | 1.14 |
| composition | | | | | | | |
| Spiral flow length | 105 | 101 | 98 | 91 | 91 | 107 | 94 |
| Notched Izod impact | 15 | 16 | 17 | 15 | 15 | 13 | 15 |
| strength | | | | | | | |
| Falling dart impact | 45 | 48 | 55 | 60 | 62 | 32 | 61 |
| strength | | | | | | | |
| Flexural modulus | 15 | 15 | 15 | 15 | 15 | 16 | 15 |
| Appearance | ◯ | ⊚ | ⊚ | ◯ | ◯ | ◯ | Δ |

* parts by weight: relative to 100 parts by weight of polyamide resin ((a1) + (a2))

From the results shown in Table 2, it can be seen that the polyamide resin compositions according to the present invention (Examples 1 to 3) have a difference in intrinsic viscosity between the polyamide resin and the polyamide resin composition of 0.01 or less and thus could reduce increase in viscosity (molecular weight) upon addition of glass fibers, and exhibit improved properties in terms of moldability (spiral flow), impact resistance (notched Izod impact strength, falling dart impact strength), stiffness (flexural modulus), appearance, and balance therebetween.

Conversely, it can be seen that the polyamide resin compositions of Comparative Examples 1 and 2 using an aliphatic polyamide resin having a concentration of a terminal amine group of 50 μeq/g or higher exhibit a large increase in viscosity (molecular weight) upon addition of glass fibers, and the polyamide resin composition of Comparative Example 3 using polyamide MXD6 instead of the aromatic polyamide resin according to the present invention exhibits poor crack resistance. In addition, the polyamide resin composition of Comparative Example 4 using an aliphatic polyamide resin alone exhibits poor properties in terms of moldability and appearance.

Although some embodiments have been described above, it should be understood that these embodiments are provided for illustration only and are not to be construed in any way as limiting the present invention, and that various modifications, changes, and alterations can be made by those skilled in the art without departing from the spirit and scope of the invention. Therefore, the scope of the present invention should be defined by the appended claims and equivalents thereof.

What is claimed is:

1. A polyamide resin composition comprising:
a base resin comprising an aliphatic polyamide resin having a concentration of a terminal amine group of about 0.1 μeq/g to about 45 μeq/g and including a repeat unit represented by the following Formula 1 and an aromatic polyamide resin including a repeat unit represented by the following Formula 2; and
inorganic fillers: 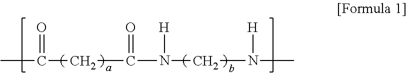
wherein a is an integer from 4 to 10, and b is an integer from 6 to 12; 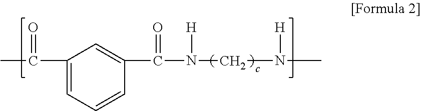
wherein c is an integer from 6 to 12.

2. The polyamide resin composition according to claim 1, wherein the aliphatic polyamide resin is present in an amount of about 50 wt % to about 90 wt % based on the total weight of the base resin; the aromatic polyamide resin is present in an amount of about 10 wt % to about 50 wt % based on the total weight of the base resin; and the inorganic fillers are present in an amount of about 50 parts by weight to about 500 parts by weight based on about 100 parts by weight of the base resin.

3. The polyamide resin composition according to claim 1, wherein the aliphatic polyamide resin has the terminal amine group and a terminal carboxyl group, a concentration of the terminal amine group ranges from about 10 μeq/g to about 40 μeq/g, and the concentration of the terminal amine group is about 0.1 times to about 0.3 times the concentration of the terminal carboxyl group.

4. The polyamide resin composition according to claim 1, wherein the aliphatic polyamide resin has an intrinsic viscosity of about 0.9 dL/g to about 1.2 dL/g; the aromatic polyamide resin has an intrinsic viscosity of about 0.6 dL/g to about 1.0 dL/g; and
the base resin has an intrinsic viscosity of about 1.0 dL/g to about 1.1 dL/g.

5. The polyamide resin composition according to claim 1, wherein the aliphatic polyamide resin is polyamide 66 and the aromatic polyamide resin is polyamide

61.

6. The polyamide resin composition according to claim 1, wherein the inorganic fillers are glass fibers, and the glass fibers take a fibrous form and have a sectional diameter of about 5 μm to about 20 μm and a ratio of minor axis to major axis of about 1:about 1 to about 1:about 6 in a cross-sectional view thereof.

7. The polyamide resin composition according to claim 6, wherein the glass fibers are surface-treated with a coupling agent comprising at least one of a urethane coupling agent, a silane coupling agent, and an epoxy coupling agent.

8. The polyamide resin composition according to claim 1, wherein the polyamide resin composition has an intrinsic viscosity of about 1.0 dL/g to about 1.1 dL/g, and a difference in intrinsic viscosity between the base resin and the polyamide resin composition is about 0.05 dL/g or less.

9. The polyamide resin composition according to claim 1, wherein the polyamide resin composition has a notched Izod impact strength of about 10 kgf·cm/cm to about 30 kgf·cm/cm, as measured on an about ⅛″ thick specimen in accordance with ASTM D256.

10. The polyamide resin composition according to claim 1, wherein the polyamide resin composition has a spiral flow length of about 95 mm to about 160 mm, as measured on a specimen prepared by injection molding under conditions of a molding temperature of about 300° C., a mold temperature of about 80° C., an injection pressure of about 1,500 kgf/cm², and an injection rate of about 120 mm/s in a spiral mold having a thickness of about 0.5 mm.

11. The polyamide resin composition according to claim 1, wherein the polyamide resin composition has a falling dart impact strength of about 40 cm to about 80 cm, as measured on an about 0.8 mm thick specimen (about 10 cm×about 10 cm×about 0.8 mm) using an about 500 g dart in accordance with the DuPont drop test method by measuring a height of the dart at which the specimen is cracked.

12. A molded article formed of the polyamide resin composition according to claim 1.
